(19) United States
(12) Patent Application Publication
(10) Pub. No.: US 2019/0380488 A1
(43) Pub. Date: Dec. 19, 2019

(54) CABINET CONTAINING CUSTOMIZED DRAWERS FOR STORING EPI-PENS

(71) Applicants: Marilyn Sawyer, Northbrook, IL (US); Mark Sawyer, Northbrook, IL (US)

(72) Inventors: Marilyn Sawyer, Northbrook, IL (US); Mark Sawyer, Northbrook, IL (US)

(21) Appl. No.: 16/009,236

(22) Filed: Jun. 15, 2018

(51) Int. Cl. A47B 81/00; A47B 88/919; A47B 88/944; G09F 7/04; A47B 88/53

(52) U.S. Cl. CPC A47B 81/00; A47B 88/919; A47B 88/53; G09F 7/04; A47B 88/944

(57) ABSTRACT

An Epi-Pen cabinet, including a body including at least one drawer receiving compartment, and at least one Epi-Pen storing drawer slidable within the at least one drawer receiving compartment, the at least one Epi-Pen storing drawer including a main body including a storage portion to store at least one Epi-Pen therein, a pop-up flag disposed within a front top portion of the main body to pop up when the main body is slid out from the at least one drawer receiving compartment, and a window disposed on a front surface of the main body to indicate a condition of the at least one Epi-Pen stored within the storage portion.

### BACKGROUND

### 1. Field

The present general inventive concept relates generally to a cabinet having drawers, and particularly, to a cabinet containing customized drawers for storing epi-pens.

### 2. Description of the Related Art

An Epi-Pen is an injection that contains epinephrine, a chemical that narrows blood vessels and opens airways in the lungs. The allergic reactions (anaphylaxis) treated with the use of an Epi-Pen include those from insect stings or bites, food, drugs, and other allergens. When the decision to use an Epi-Pen is made, any delay in searching for the medication and retrieving the right one for the right person is costly and increases the risk of having a life-threatening reaction. Storing multiple Epi-Pens together in a drawer or bin adds to the delay and the stress of dealing with this type of situation, which is why it is important to have a way to keep medications organized and stored for quick convenience.

Therefore, there is a need for a storage device that stores and organizes Epi-Pens.

### SUMMARY

The present general inventive concept provides a cabinet containing customized drawers for storing epi-pens.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an Epi-Pen cabinet, including a body including at least one drawer receiving compartment, and at least one Epi-Pen storing drawer slidable within the at least one drawer receiving compartment, the at least one Epi-Pen storing drawer including a main body including a storage portion to store at least one Epi-Pen therein, a pop-up flag disposed within a front top portion of the main body to pop up when the main body is slid out from the at least one drawer receiving compartment, and a window disposed on a front surface of the main body to indicate a condition of the at least one Epi-Pen stored within the storage portion.

The at least one Epi-Pen drawer may further include a movable lever including a plurality of color indicators on a front surface thereof to allow the window to indicate the condition of the at least one Epi-Pen stored within the storage portion, and a slot disposed on the front top portion of the main body to receive the movable lever therein and to allow the movable lever to move thereinside.

The plurality of color indicators may include a first color indicator having a white color to indicate that the Epi-Pen storing drawer is empty, a second color indicator having a green color to indicate that the at least one Epi-Pen is stocked and in good condition, a third color indicator having a yellow color to indicate that the at least one Epi-Pen is near expiration, and a fourth color indicator having a red color to indicate that the at least one Epi-Pen is expired.

The at least one Epi-Pen drawer may further include a magnetically detachable label to attach to the front surface of the main body of the at least one Epi-Pen drawer, the magnetically detachable label including a dry-erase front surface, and a window portion to correspond to the window of the at least one Epi-Pen drawer.

The pop-up flag may be spring-loaded and prevents the at least one Epi-Pen storing drawer from closing when the pop-up flag is popped up.

The Epi-Pen cabinet may further include at least one attachment portion to allow the Epi-Pen cabinet to be hung from a wall.

The Epi-Pen cabinet may be stackable with respect to other Epi-Pen cabinets.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an Epi-Pen storing drawer, according to an exemplary embodiment of the present general inventive concept; and

FIG. 2 illustrates an Epi-Pen cabinet including a plurality of Epi-Pen storing drawers, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

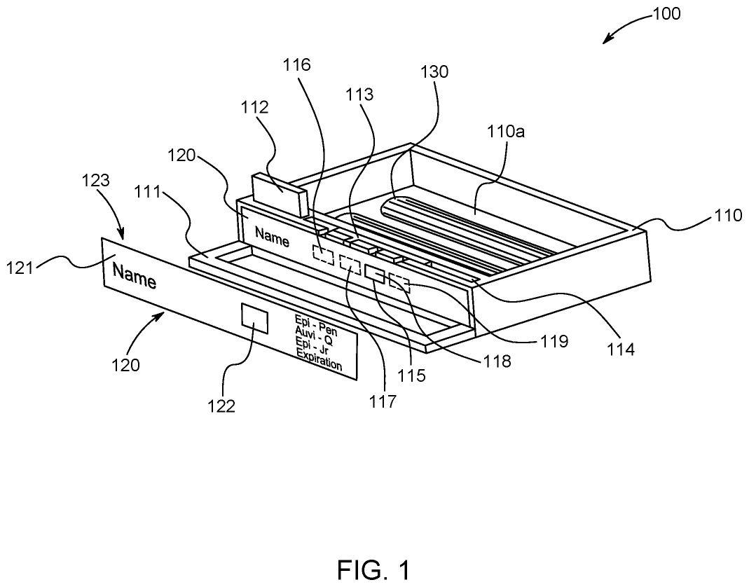

FIG. 1 illustrates an Epi-Pen storing drawer 100, according to an exemplary embodiment of the present general inventive concept.

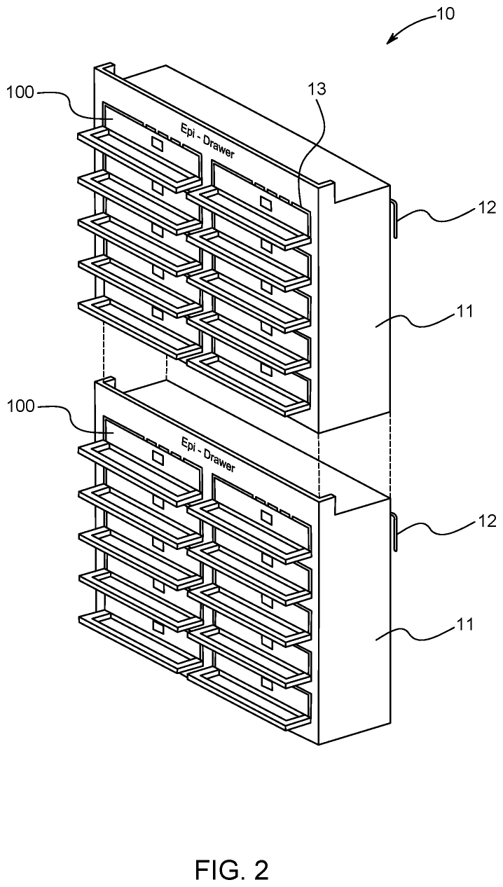

FIG. 2 illustrates an Epi-Pen cabinet 10 including a plurality of Epi-Pen storing drawers 100, according to an exemplary embodiment of the present general inventive concept.

The Epi-Pen storing drawer 100 and the Epi-Pen cabinet 10, and components thereof, may be constructed from plastic, metal, wood, rubber, magnets, cloth, or any other material known to one of ordinary skill in the art.

Dimensions, sizes, and shapes of the Epi-Pen storing drawer 100 and the Epi-Pen cabinet 10 may vary to accommodate medication and/or Epi Pens of various sizes and shapes.

The Epi-Pen storing drawer 100 may include a main body 110, a label 120, and at least one Epi-Pen 130, but is not limited thereto.

The main body 110 may include a handle 111, a pop-up flag 112, a movable lever 113, a slot 114, a window 115, a first color indicator 116, a second color indicator 117, a third color indicator 118, and a fourth color indicator 119.

The handle 111 may be disposed on a front surface of the main body 110, and may be used to pull out the Epi-Pen storing drawer 100 from the Epi-Pen cabinet 10 in order to extract the at least one Epi-Pen 130 from the Epi-Pen storing drawer 100.

The pop-up flag 112 may be mechanically connected to an inner portion of the main body 100, specifically, at a top portion of the front surface of the main body 110. As such, the pop-up flag 112 may be spring-loaded to pop up when the Epi-Pen storing drawer 100 is pulled out of the cabinet 10, such that the Epi-Pen storing drawer 100 cannot be closed again due to the pop-up flag 112 being popped up. In other words, the pop-up flag 112 may prevent the Epi-Pen storing drawer 100 from being closed into the cabinet 10.

The slot 114 may be a slot grooved into the top portion of the front surface of the main body 110.

The movable lever 113 may be disposed within the slot 114, and may be movable within the slot 114.

The window 115 may be disposed on a front surface of the body 110.

The first color indicator 116, the second color indicator 117, the third color indicator 118, and the fourth color indicator 119 may all be disposed on a front surface of the movable lever 113, such that movement of the movable lever 113 along the slot 114 may allow one of the first color indicator 116, the second color indicator 117, the third color indicator 118, and the fourth color indicator 119 to be visible through the window 115. As such, the window 115 may be used to indicate a condition of the at least one Epi-Pen 130 stored within the storage portion 110a.

Specifically, the first color indicator 116 may be a white color to indicate that the Epi-Pen storing drawer 100 is empty, the second color indicator 117 may be a green color to indicate that the at least one Epi-Pen 130 is stocked and in good condition, the third color indicator 118 may be a yellow color to indicate that the at least one Epi-Pen 130 is near expiration, and the fourth color indicator 119 may be a red color to indicate that the at least one Epi-Pen 130 is expired. As such, the movable lever 113 may be moved along the slot 114 to allow the first color indicator 116, the second color indicator 117, the third color indicator 118, or the fourth color indicator 119 to be viewable through the window 115.

The label 120 may include a dry erase front surface 121, a window portion 122, and a magnetized rear surface 123.

The user may write on the dry erase front surface 121 with a marker to label the label 120 in any way the user desires.

The window portion 122 may correspond to the window 115 of the body 110, so that the user may view the first color indicator 116, the second color indicator 117, the third color indicator 118, or the fourth color indicator 119 therethrough when the label 120 is attached to the front surface of the body 110 using the magnetized rear surface 123. Although the magnetized rear surface 123 preferably includes at least one magnet to allow the label 120 to attach to the front surface of the body 110, other attachment means, such as tape, glue, hooks, loops, etc., may be used as alternative attachment mechanisms.

The at least one Epi-Pen 130 may be stored within a storage portion 110a of the body 110. The at least one Epi-Pen 130 may also be any other type of medication known to one of ordinary skill in the art.

When the user needs to extract the at least one Epi-Pen 130 from the Epi-Pen storing drawer 100, the user may pull on the handle 111, pull out the Epi-Pen storing drawer 100 from the Epi-Pen cabinet 10, remove the at least one Epi-Pen 130, and then optionally move the movable lever 113 to a position such that the first color indicator 116 is viewable through the window 115, denoting that the Epi-Pen storing drawer 100 is empty.

Also, when the pop-up flag 112 is up, the Epi-Pen storing drawer 100 cannot be closed completely, therefore reminding a nurse that the at least one Epi-Pen 130 needs to be replenished. The front outside portion of the Epi-Pen storing drawer 100 or the label 120 may be labeled with indicators indicating Name, type of medication, and expiration date. The label 120 could be a certain color depending on the medication. If one of the Epi-Pen storing drawers 100 is empty, a safety latch may be engaged over the pop-up flag 112 to keep it from coming up.

The Epi-Pen storing drawer 100 may be mounted to the Epi-Pen cabinet 10 horizontally or vertically. Also, multiple Epi-Pen cabinets 10 may be stacked on each other as desired.

The Epi-Pen cabinet 10 may include a body 11 that may receive the Epi-Pen storing drawer 100 therein, and may also include at least one attachment member 12 to allow the Epi-Pen cabinet 10 to be attached to a wall. Specifically, the Epi-Pen cabinet 10 may include a plurality of slidable Epi-Pen storing drawers 100 that are received in drawer receiving compartments 13, as illustrated in FIG. 2. In other words, the drawer receiving compartments 13 may be apertures that are sized to each receive one of the Epi-Pen storing drawers 100 therein. The at least one attachment member 12 may be a hook, tape, etc., but is not limited thereto.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An Epi-Pen cabinet, comprising:
a body comprising at least one drawer receiving compartment; and
at least one Epi-Pen storing drawer slidable within the at least one drawer receiving compartment, the at least one Epi-Pen storing drawer comprising:
a main body including a storage portion to store at least one Epi-Pen therein,
a pop-up flag disposed within a front top portion of the main body to pop up automatically in response to the main body sliding out from the at least one drawer receiving compartment, such that the pop-up flag remains up when the at least one drawer is closed,
a safety latch disposed on a portion of the main body to prevent the pop-up flag from coming up in response to being engaged to the pop-up flag, and
a window disposed on a front surface of the main body to indicate a condition of the at least one Epi-Pen stored within the storage portion.

2. The Epi-Pen cabinet of claim 1, wherein the at least one Epi-Pen drawer further comprises:
a movable lever including a plurality of color indicators on a front surface thereof to allow the window to indicate the condition of the at least one Epi-Pen stored within the storage portion; and
a slot disposed on the front top portion of the main body to receive the movable lever therein and to allow the movable lever to move thereinside.

3. The Epi-Pen cabinet of claim 2, wherein the plurality of color indicators comprise:
a first color indicator having a white color to indicate that the Epi-Pen storing drawer is empty;
a second color indicator having a green color to indicate that the at least one Epi-Pen is stocked and in good condition;
a third color indicator having a yellow color to indicate that the at least one Epi-Pen is near expiration; and
a fourth color indicator having a red color to indicate that the at least one Epi-Pen is expired.

4. The Epi-Pen cabinet of claim 1, wherein the at least one Epi-Pen drawer further comprises:
a magnetically detachable label to attach to the front surface of the main body of the at least one Epi-Pen drawer, the magnetically detachable label comprising:
a dry-erase front surface, and
a window portion to correspond to the window of the at least one Epi-Pen drawer.

5. The Epi-Pen cabinet of claim 1, wherein the pop-up flag is spring-loaded and prevents the at least one Epi-Pen storing drawer from closing when the pop-up flag is popped up.

6. The Epi-Pen cabinet of claim 1, wherein the Epi-Pen cabinet further comprises:
at least one attachment portion to allow the Epi-Pen cabinet to be hung from a wall.

7. The Epi-Pen cabinet of claim 1, wherein the Epi-Pen cabinet may be stackable with respect to other Epi-Pen cabinets.
